(19) United States
(12) Patent Application Publication
(10) Pub. No.: US 2006/0001838 A1
(43) Pub. Date: Jan. 5, 2006

(54) Illuminating device and projection type video display

(75) Inventors: Shouichi Yoshii, Osaka (JP); Yoshihiro Yokote, Osaka (JP); Takashi Ikeda, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/169,880

(22) Filed: Jun. 30, 2005

(30) Foreign Application Priority Data
Jul. 5, 2004 (JP) 2004-198495

(51) Int. Cl. G03B 21/00

(52) U.S. Cl. 353/31

(57) ABSTRACT

A projection type video display is provided with three illuminating devices R, G, B. The illuminating device R emits light in red, the illuminating device G emits light in green, and the illuminating device B emits light in blue. The lights emitted from the respective illuminating devices are guided onto transparent liquid crystal display panels R, G, B by convex lenses. Each illuminating device is formed of a light source, a light guide, a condenser lens, and an integrator lens. The light source is formed of having one or a plurality of LED chips aligned on a plain surface. The LED chips have photonic crystal structure, and a light-emission direction approximately vertical to a light-emitting surface, thus high in directionality.

### BACKGROUND OF THE INVENTION

1. Field of the Invention

The present invention relates to an illuminating device and a projection type video display.

2. Description of the Prior Art

A generally used illuminating device used for a liquid crystal projector, and others is formed of a lamp such as an ultra-high pressure mercury lamp, a metal halide lamp, a xenon lamp, and others, and a parabolic reflector for collimating its irradiated light. Furthermore, in such the illuminating device, there is provided an integrating function (referring to a function for superimposing and converging onto an object to be illuminated a plurality of illuminating areas in a predetermined shape formed in a sampling manner on a plain surface by an optical device) by a pair of fly's eye lenses in order to prevent non-uniformity of light on an irradiating surface. Furthermore, in recent years, in view of reduction in size and weight, it is attempted to use a light-emitting diode (LED) as a light source (see Japanese Patent Laying-open No. 10-186507).

However, it appears to be a reality that a practical illuminating device using the light-emitting diode has not been realized.

### SUMMARY OF THE INVENTION

In view of the above circumstances, it is an object of the present invention to provide a practical illuminating device using a solid light element such as a light-emitting diode and projection type video display using the illuminating device.

In order to solve the above-described problems, an illuminating device according to the present invention comprises a light source provided with one or a plurality of solid light-emitting elements, at least one of a light guide having an area of a light-exit surface larger than an area of a light-incident surface located on a side of the light source, and a lens for collimating light emitted from the light source, a first fly's eye lens upon which the light exited from the light guide or the lens is incident, and a second fly's eye lens arranged in such a manner as to be paired with the first fly's eye lens, and integrating and guiding light to an object to be illuminated (Hereinafter, referred to as a first configuration in this section).

In addition, an illuminating device according to the present invention comprises a light source provided with one or a plurality of solid light-emitting elements, a first fly's eye lens arranged close to a light-emission side of each solid light-emitting element and having two or more convex lens portions allotted to each solid light-emitting element, and a second fly's eye lens arranged in such a manner as to be paired with the first fly's eye lens and integrating and guiding light to an object to be illuminated (Hereinafter, referred to as a second configuration in this section).

In the first or second configuration, an illuminating device may be provided with a polarization conversion system having a plurality of polarizing beam splitters for redirecting to a common polarization direction, on a light-exit side of the second fly's eye lens.

In addition, an illuminating device according to the present invention comprises a polarization conversion system having a plurality of polarizing beam splitters for redirecting to a common polarization direction, one or a plurality of solid light-emitting elements arranged close to a light-incident side of the polarization conversion system, and a light integrating means for integrating and guiding exited light from the polarization conversion system to an object to be illuminated (Hereinafter, referred to as a third configuration in this section).

In the above-described third configuration, it may be possible that the light integrating means is formed of a first fly's eye lens, and a second fly's eye lens arranged in such a manner as to be paired with the first fly's eye lens. Or in the above-described third configuration, it may be possible that the light integrating means may be a rod integrator formed in a tube or a pole shape.

Furthermore, an illuminating device according to the present invention comprises a light source formed of a plurality of solid light-emitting elements, and a means for rendering uniform a light-emitting amount or a light-emitting color of each solid light emitting element (Hereinafter, referred to as a fourth configuration in this section).

In the above-described fourth configuration, it may be configured such that the light-emitting color and the light-emitting amount are controlled by controlling an electric current value supplied to the solid light-emitting elements. In addition, it may be configured such that the light-emitting amount is controlled by controlling a pulse width of an electric current supplied to the solid light-emitting elements. In these illuminating devices, it may be possible that there is provided an optical system in which light is guided to an object to be illuminated without applying a light integration to the light from the light source. Or, it may be configured such that the light source is arranged close to an object to be illuminated, and light from the light source is directly guided to the object to be illuminated.

In these illuminating devices, it may be preferable that an aspect ratio of each solid light-emitting element is rendered equal to or approximately equal to an aspect ratio of the object to be illuminated. In addition, it may be preferable that the solid light-emitting elements are formed of light-emitting diodes having photonic crystals. The light-emitting diodes having the photonic crystals may have a light-emission direction approximately vertical to a light-emitting surface.

Furthermore, a projection type video display of the present invention is a projection type video display for modulating light emitted from an illuminating device by a display device and projecting the modulated light, and comprises any one of the illuminating devices described above and the display device is an object to be illuminated. In such the projection type video display, it may be configured such that three pieces of the display devices are provided for respective colors, the three illuminating devices are provided for the respective colors, and lights via the three pieces of display devices are combined and projected.

In addition, a projection type video display comprises a self-light-emitting display device having a plurality of solid light-emitting elements as pixels, and a projection optical element for projecting emitted image light from the self-light-emitting display device. In the projection type video display of such the configuration, it may be configured such that three pieces of the display devices are provided for respective colors, the three self-light-emitting display devices are provided for the respective colors, and emitted image light from the three pieces of self-light-emitting display devices are composed and projected. Furthermore, the solid light-emitting elements in the display devices may be formed of light-emitting diodes having photonic crystals. In addition, the light-emitting diodes having the photonic crystals may have a light-emission direction approximately vertical to a light-emitting surface.

As described above, the present invention exhibits an effect that it is possible to provide a practical illuminating device using a solid light-emitting element such as a light-emitting diode, and others, and projection type video display using the illuminating device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a descriptive diagram showing an optical system of an illuminating device and a projection type video display of an embodiment of the present invention;

FIG. 2 is a descriptive diagram showing an aspect ratio of a liquid crystal display panel;

FIG. 3 is a descriptive diagram showing a basic unit of a polarization conversion system of an embodiment of the present invention;

FIG. 4 is a descriptive diagram showing an optical system of an illuminating device and a projection type video display of an embodiment of the present invention;

FIG. 5 is a descriptive diagram showing an optical system of an illuminating device and a projection type video display of an embodiment of the present invention;

FIG. 6 A is a lateral view showing a polarization conversion system using four basic units, and others;

FIG. 6 B is a plain view showing a polarization conversion system using the four basic units;

FIG. 7 is a descriptive diagram showing an example of a configuration in which an integrator lens is provided instead of a rod integrator in the FIG. 6 configuration;

FIG. 8 is a plain view showing a polarization conversion system in which two basic units are arranged in a checkered pattern;

FIG. 9 is a plain view showing a light source in which LED chips are arranged in an array shape;

FIG. 10 is a descriptive diagram showing an illuminating device using a light source in which a light-emitting amount and a color in LED chips are rendered uniform;

FIG. 11 is a descriptive diagram showing a configuration in which a liquid crystal display panel is arranged closer to a light-emission side of a light source in which a light-emitting amount and a color in LED chips are rendered uniform;

FIG. 12 is a plain view showing a self-light-emitting video display panel; and

FIG. 13 is a descriptive diagram showing a projection type video display having a self-light-emitting video display panel.

### DESCRIPTION OF THE PREFERRED EMBODIMENTS

### A First Embodiment

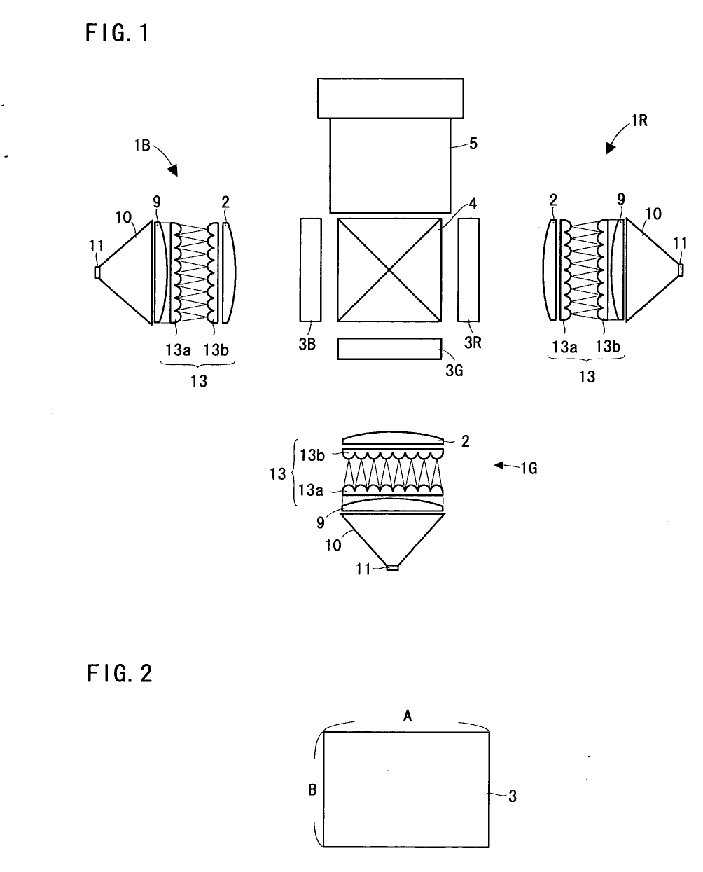

Hereinafter, an illuminating device and a projection type video display will be described referring to FIG. 1 to FIG. 9.

FIG. 1 is a diagram showing an optical system of a three-panel projection type video display. The projection type video display is provided with three illuminating devices 1R, 1G, 1B (Hereinafter, a numeral “1” is used when generally referring to the illuminating device). The illuminating device 1R emits light in red, the illuminating device 1G emits light in green, and the illuminating device 1B emits light in blue. The lights emitted from each illuminating device 1 are guided by a convex lens 2 to respective colors-use transparent liquid crystal display panels 3R, 3G, 3B (Hereinafter, a numeral “3” is used when generally referring to the liquid crystal display panel). It is noted that in this embodiment, one piece of the convex lens 2 is described. However, it may be configured to be formed of a plurality of lenses. Each liquid crystal display panel 3 is formed of being provided with a light-incidence-side polarizer, a panel portion formed by sealing a liquid crystal between one pair of glass plates (a pixel electrode and an alignment film are formed), and a light-exit-side polarizer. Modulated light (image light of the respective colors) modulated by passing through the liquid crystal display panels 3R, 3G, 3B is combined by a dichroic prism 4, and changed to full-color image light. This full-color image light is projected by a projection lens 5, and displayed on a screen.

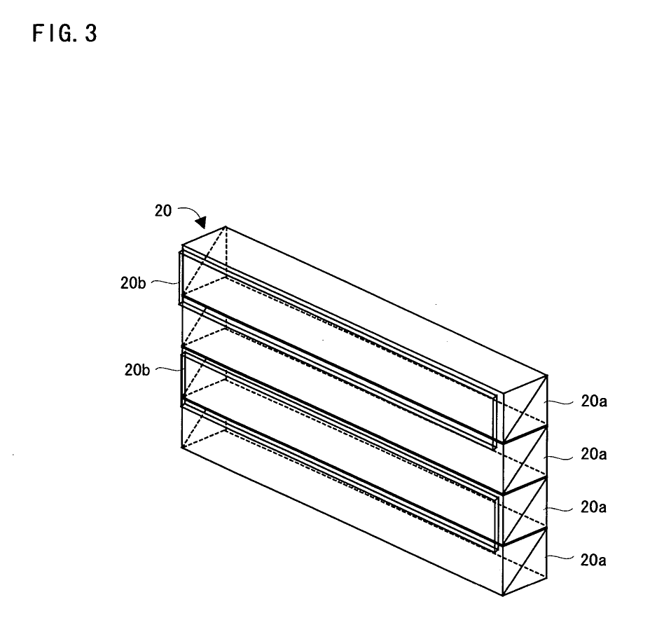

FIG. 2 is a front view showing the liquid crystal display panel 3. The liquid crystal display panel 3 has an aspect ratio of horizontal A to vertical B. The ratio of A to B is 4:3, 16:9, and others, for example.

Each illuminating device 1 is formed of a light source 11, a light guide 10, a condenser lens 9, and an integrator lens 13. The light source 11 is formed of having one or a plurality of LED chips (light-emitting diode chips) arranged on a plain surface. In this embodiment, and embodiments that follow, an aspect ratio of the LED chips coincides or approximately coincides with that of the liquid crystal display panel 3, which is an object to be illuminated. Furthermore, the LED chips have photonic crystal structures, and a light-emission direction is approximately vertical to a light-emitting surface, hence high in directionality. In addition, in a case that the light source 11 is configured of a plurality of photonic crystal-type LED chips, intervals between the LED chips can be rendered as narrow as possible. It is noted that the photonic crystal is a man-made crystal in which a dielectric constant is modulated periodically.

The light guide (light pipe) 10 has an area of a light-exit surface larger than that of a light-incidence surface (located on a side of the light source 11), and is formed of a glass block or in a tube shape of which inner surface is a mirror surface, for example. Emitted light from the light source 11 is reflected within the light guide 10, and this improves parallelism of the light exited from the light guide 10. The condenser lens 9 is a lens for collimating the light emitted from the light source 11, and as a result of this condenser lens 9 being provided, the parallelism of the light is further improved. Although in this embodiment, both the light guide 10 and the condenser lens 9 are provided, it is possible to adopt a configuration in which only one of the two is provided.

The integrator lens 13 is configured of one pair of fly's eye lenses 13a, 13b, and each pair of the lenses guides the light emitted from the light source 11 onto an entire surface of the liquid crystal display panel 3. This, even if there is light-emitting non-uniformity (luminance non-uniformity) in each LED chip of the light source 11, or there is luminance non-uniformity within the light-exit surface of the light guide 10, makes it possible to obtain uniformity of the luminance in a light flux guided on the liquid crystal display panel 3. An aspect ratio of each lens portion in the fly's eye lenses 13a, 13b approximately coincides with that of the liquid crystal display panel 3. This holds equally for embodiments described below.

It may be possible that a polarization conversion system is provided between the integrator lens 13 and the convex lens 2. As shown in FIG. 3, a basic unit of the polarization conversion system 20 is formed of two polarization beam splitters (PBSs) 20a, 20a, and a retardation plate (½ λ plate) 20b arranged on a light-exit side of one of the two polarization beam splitters 20a. A polarized light separating surface of each polarization beam splitter 20a transmits P-polarized light, and changes an optical path of S-polarized light by 90 degrees. The S-polarized light having the optical path changed is reflected by an adjacent polarized light separating surface, and is exited as it is. On the other hand, the P-polarized light that passes through the polarized light separating surface is converted into the S-polarized light by the retardation plate 20b provided on a front side of the polarized light separating surface (on the light-exit side), and exited. That is, in an example of FIG. 3, approximately all light is converted into the S-polarized light.

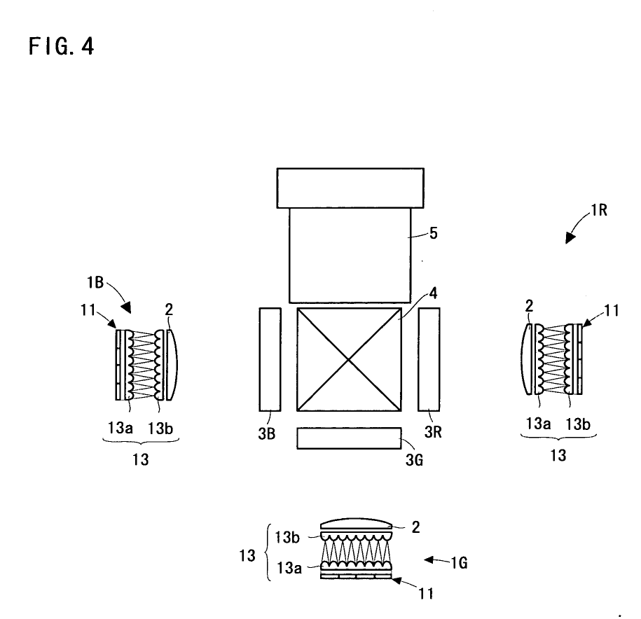

FIG. 4 is a diagram showing another optical system of the projection type video display. The illuminating device 1 of this optical system is not provided with the light guide 10 and the condenser lens 9. In addition, the light source 11 is formed by having a plurality of LED chips aligned on a plain surface, and has a plurality of convex lens portions (two, four, and more, for example) in the integrator lens 13 facing one LED chip. Thus, as a result of having a plurality of the convex lens portions in the integrator lens 13 facing each LED chip, even if there is light-emitting non-uniformity (luminance non-uniformity) in each LED chip of the light source 11, uniformity of the luminance is obtained in a light flux guided on the liquid crystal display panel 3. In a case of using the LED chip having photonic crystal structure, it becomes possible to adhere the LED chips to an even surface side of the fly's eye lens 13a.

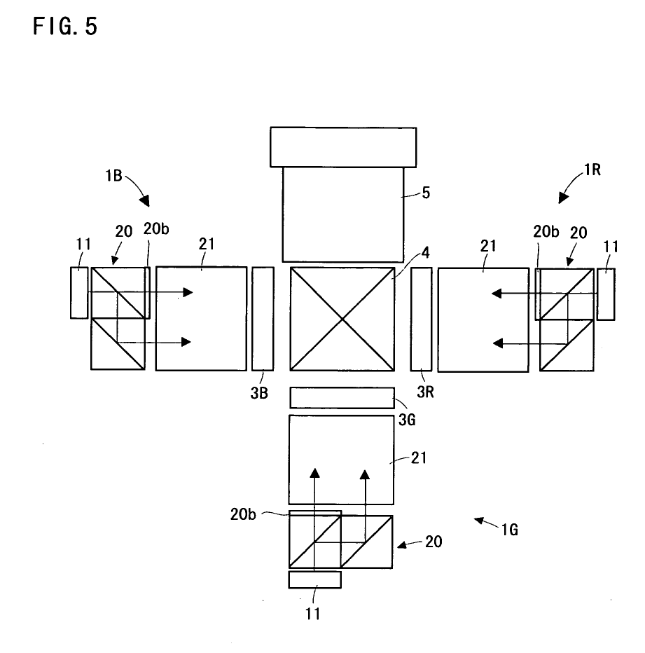

FIG. 5 is a diagram showing another optical system of the projection type video display. The illuminating device 1 of this optical system is formed of the light source 11, the polarization conversion system 20, and a rod integrator 21. The light source 11 is formed by having one or a plurality of LED chips aligned on a plain surface. The LED chips have photonic crystal structure, and a light-emission direction approximately vertical to a light-emitting surface, hence high in directionality. In a case that the light source 11 is configured of a plurality of photonic crystal-type LED chips, intervals between the LED chips can be rendered as narrow as possible.

The light source 11 (LED chip) is arranged close to a light-incidence surface of the polarization conversion system 20. In this embodiment, a size of the light source 11 is rendered coincident with or approximately coincident with that of the light-incidence surface of the polarization conversion system 20. It is also possible to bring the light source 11 and the polarization conversion system 20 into close contact. The polarization conversion system 20 is configured of having one or a plurality of basic units. In this example, light from the light source 11 is converted by the polarization conversion system 20 into S-polarized light before being exited therefrom. On a light-exit side of the polarization conversion system 20, a rod integrator 21 is arranged. The rod integrator 21, even if there is light-emitting unevenness (luminance non-uniformity) in each LED chip of the light source 11, or even if there is a difference in luminance depending on each LED chip, or even if there is luminance non-uniformity within the light-exit surface of the polarization conversion system 20, makes it possible to obtain uniformity of the luminance in a light flux guided on the liquid crystal display panel 3.

Light exited from the polarization conversion system 20 is optically integrated by the rod integrator 21 before being incident on the liquid crystal display panel 3, and light modulated by the liquid crystal display panel 3 is incident on a cross dichroic prism 4.

A light-emission direction of the light source 11 (LED chip) is approximately vertical to the light-emitting surface of the light source 11, hence high in directionality, and the light source 11 (LED chip) is arranged close to the polarization conversion system 20, so that even if the emitted light from the light source 11 (LED chip) is directly incident onto the polarization conversion system 20, almost all of the light is used, which results in high utilization efficiency of the light.

Herein, if an entire size of one or a plurality of the LED chips provided to be close to each basic unit of the polarization conversion system 20 is several millimeters by several millimeters, a difference in an optical pass length between transmitting and reflecting light fluxes within the basic unit, too, is several millimeters long, thus the difference in an optical pass length in the basic unit is short, which further improves the utilization efficiency of the light.

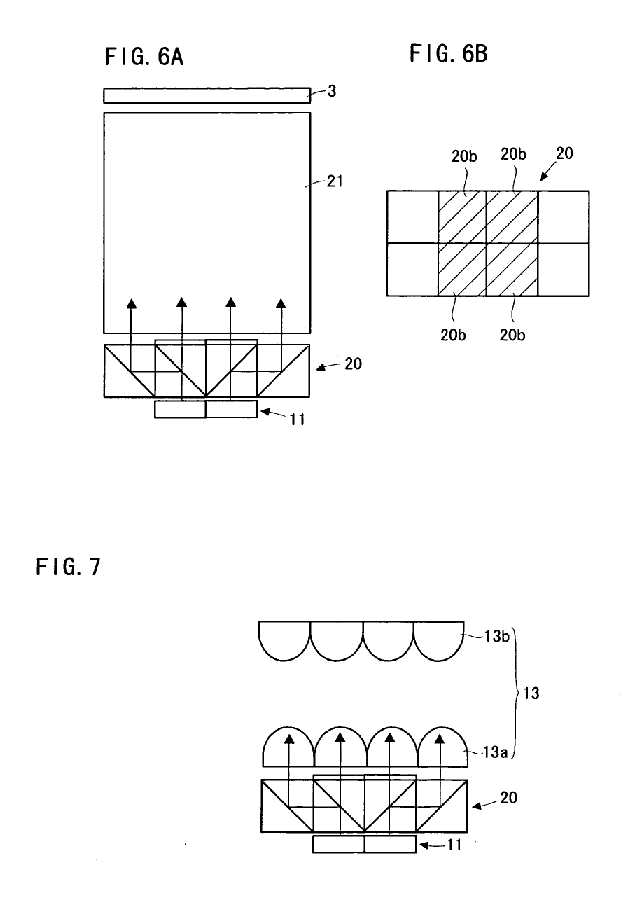

FIG. 6 A, B illustrate the polarization conversion system 20 using four basic units as an example. In an example in this FIG. 6, retardation plates 20b (LED chips) are arranged and positioned in a center portion of the polarized light separating surface. Herein, a case that the light source 11 is configured of one LED chip will be considered. If this one LED chip is four millimeters by four millimeters, light-incidence surfaces of each basic unit are two millimeters by two millimeters. That is, instead of attaching to the LED chip of a certain size a polarization beam splitter of the same size as the LED chip, it may be possible to attach a polarization beam splitter divided into a plurality of areas having small light-incidence surfaces to the LED chip. In addition, in this example, a configuration in which the rod integrator 21 is provided so as to reduce the luminance non-uniformity is adopted.

FIG. 7 shows an example of a configuration in which the integrator lens 13 is provided instead of the rod integrator 21 in FIG. 6. Each lens portion in the integrator lens 13 approximately coincides with a width of each polarization beam splitter. Therefore, even in a case that there is a difference in luminance between a position where the retardation plates 20b exist and a position where no retardation plates 20b exist, the light is guided to the liquid crystal display panel 3 while the luminance of the light is maintained uniform.

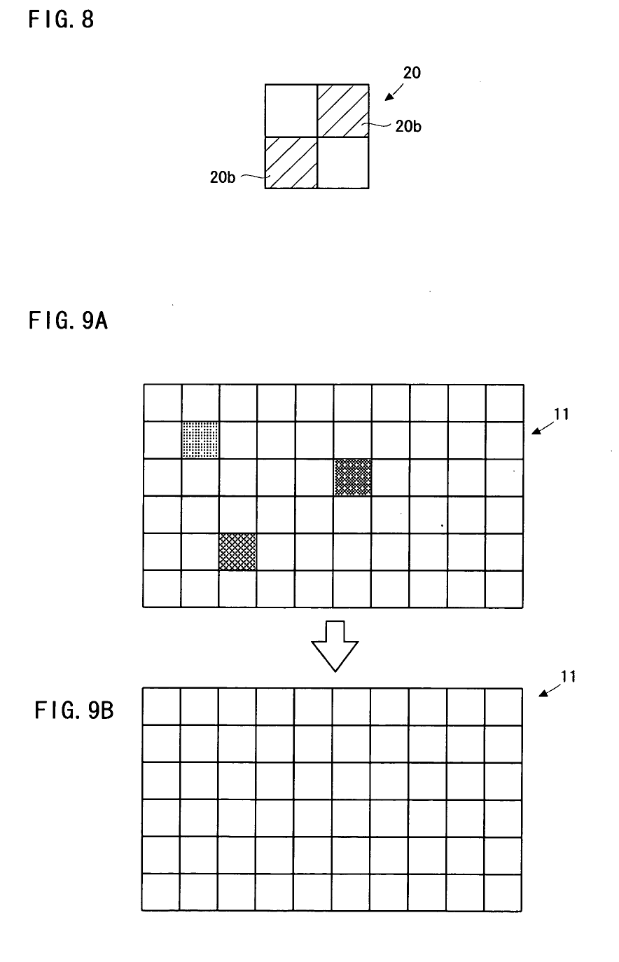

FIG. 8 illustrates a polarization conversion system 20 using two basic units as an example. In an example of this FIG. 8, it is configured that an arrangement (shaded portions in FIG. 8) of the retardation plates 20b (LED chips) is an oblique arrangement (in a checkered-pattern arrangement). As a result of the oblique arrangement like this, compared to a case of a vertically aligned arrangement, or a horizontally aligned arrangement, the luminance non-uniformity is reduced, and in addition, a radiating effect of heat, too, is improved.

### A Second Embodiment

Hereinafter, an illuminating device and a projection type video display of an embodiment of the present invention will be described based on FIG. 9 to FIG. 11.

FIG. 9 is a plain view showing the light source 11 formed by having the LED chips arranged in an array shape (vertically 6 pieces by horizontally 10 pieces). A portion (a) in FIG. 9 shows a state that there is a disparity of a light amount and a light-emitting color in each LED chip stemming from a difference in individual characteristic of each LED chip, and an adjustment for rendering uniform therefor is not performed. A portion (b) in FIG. 9 shows a state that the adjustment for rendering uniform for the light amount and the light-emitting color is performed.

The LED chips have photonic crystal structure, and a light-emission direction is approximately vertical to a light-emitting surface, hence high in directionality. In addition, in a case that the light source 11 is configured of a plurality of photonic crystal-type LED chips, intervals between the LED chips can be rendered as narrow as possible.

Each LED chip is provided with separate power supplying circuit. In each power supplying circuit, an electric current value supplied to the LED chip and an electric-current supply ON time period per a unit time-period are controlled. As a result of the electric current value being controlled, it becomes possible to control a dominant wavelength of light emitted from the LED chips. In addition, as a result of the electric-current supply ON time period per a unit time-period being controlled, it becomes possible to increase or decrease the light-emitting amount of the LED chips. The adjustment for rendering uniform the light-emitting amount and the light-emitting color in the LED chips may be performed by a visual examination by a user (tester), or by numerically converting the light-emitting amount and the light-emitting color of each LED chip using a sensor such as an imaging element, and others.

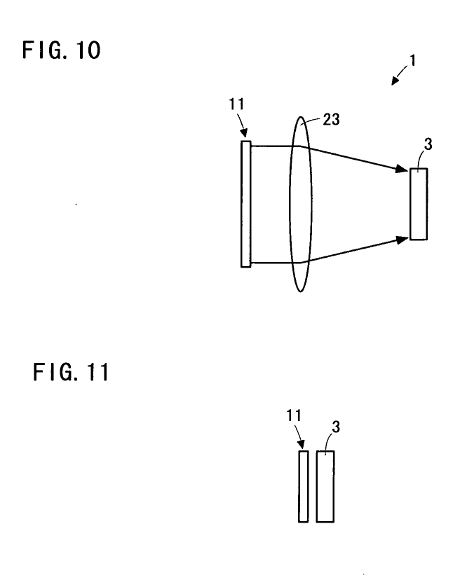

FIG. 10 shows a descriptive diagram showing an illuminating device using the light source 11 in which the light-emitting amount and the light-emitting color in the LED chips are rendered uniform. The light source 11 has an area larger than that of the liquid crystal display panel 3, has a light flux from the light source 11 converged and by using a lens 23 so as to adjust or correspond to a size of the liquid crystal display panel 3. Light modulated by passing through the liquid crystal display panel 3 is combined by a cross dichroic prism with image light in other colors, and projected.

In FIG. 11, the liquid crystal display panel 3 is arranged close to a light-emission side of the light source 11 in which the light-emitting amount and the light-emitting color in the LED chips are rendered uniform. Light modulated by passing through the liquid crystal display panel 3 is composed by the cross dichroic prism with image light in other colors, and projected.

In each configuration of FIG. 10 and FIG. 11, the light integrator is not provided. That is, by using the light source 11 in which the light-emitting amount and the light-emitting color in the LED chips are rendered uniform, an illumination optical system in which the light integrator is not provided is realized. It is noted that a small-sized polarization conversion system (basic unit) may be arranged closely to every LED chip constituting the light source 11, or to every several piece of the LED chips. In this case, intervals (which approximately coincide with a width of one PBS of the basic unit) may be provided between columns or rows of the LED chips arranged in the array shape.

In the projection type video displays described above, it may be possible to use not only a transmission-type liquid crystal display panel but also a reflection-type liquid crystal display panel. In addition, instead of these liquid crystal display panels, it may be possible to use a type of a display panel for independently driving micro mirrors, which are pixels. Furthermore, although the present invention is provided with the three illuminating devices 1R, 1G, 1B for emitting light in respective colors, an illuminating device for emitting light in white is used, and the light in white may be separated by a dichroic mirror and the like. Or, the illuminating device for emitting light in white is used, and the light in white is guided to a single-panel color display panel without being separated. In a case of using the illuminating device for emitting the light in white, each solid light-emitting element may emit the light in white, and it may be configured such that the solid light-emitting elements for emitting light in red, light in blue, and light in green are appropriately aligned. In addition, the solid light-emitting element is not limited to a light-emitting diode (LED).

### A Third Embodiment

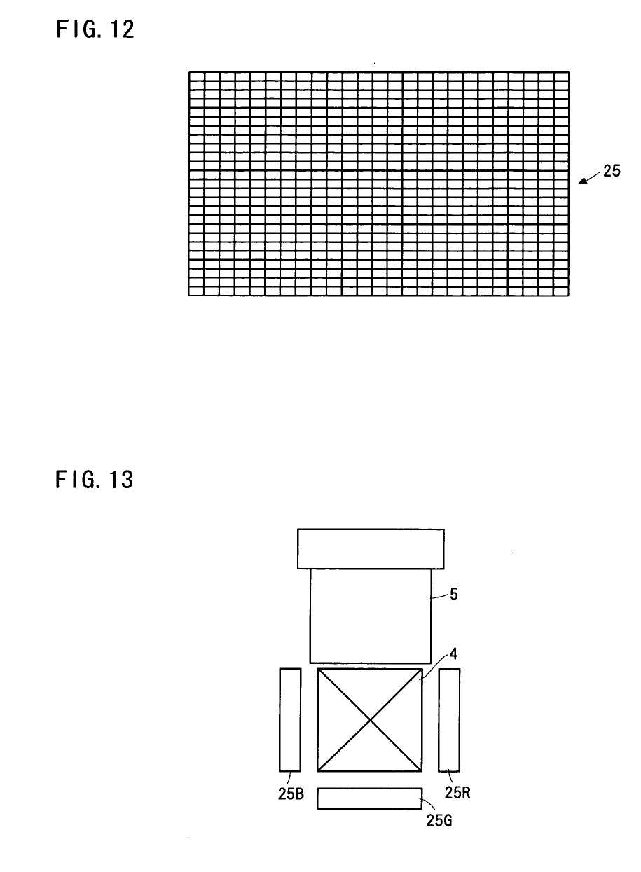

Hereinafter, a projection type video display of an embodiment of the present invention will be described based on FIG. 12 to FIG. 13.

A projection type video display of this embodiment is not provided with an illuminating device, and provided with a self-light-emitting video display panel 25. FIG. 12 shows a plain view showing the self-light-emitting video display panel 25. This self-light-emitting video display panel 25 is formed of having LED chips arranged in an array shape (vertical 25 pieces by horizontal 25 pieces in FIG. 12).

The LED chips have photonic crystal structure, and a light-emission direction approximately vertical to a light-emitting surface, hence high in directionality. In addition, in a case that the self-light-emitting video display panel 25 is configured of a plurality of photonic crystal-type LED chips, intervals of the LED chips are rendered as narrow as possible.

To the self-light-emitting video display panel 25, a driver not shown is connected. For this driver, it is possible to use a generally used driver for the self-light-emitting video display panel using the LED, an organic electroluminescence element, and others. Such the driver has a matrix configuration having a plurality of signal lines and a plurality of scanning lines, and configured of being provided with a signal line driver and a scanning line driver. A controller in the driver allows the scanning line driver to select the scanning lines subject to be displayed, and toward each LED chip on the scanning lines, performs an electric-current supply control corresponding to an input video signal, using the signal line driver. For a gradation display, the electric-current supply control changes an electric current value (amplitude), and controls an electric-current supply ON time-period per a unit time period (one horizontal scanning period).

FIG. 13 is a diagram showing an optical system of a three-panel projection type video display using the self-light-emitting video display panel 25. This projection type video display is provided with three self-light-emitting video display panels 25R, 25G, 25B. The self-light-emitting video display panel 25R emits image light in red, the self-light-emitting video display panel 25G emits image light in green, and the self-light-emitting video display panel 25B emits image light in blue. Image lights in respective colors emitted from each self-light-emitting video display panel 25 are combined by a dichroic prism 4, and changed to full-color image light. The full-color image light is projected by a projection lens 5, and displayed on a screen.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. An illuminating device, comprising:
a light source provided with one or a plurality of solid light-emitting elements;
at least one of a light guide having an area of a light-exit surface larger than an area of a light-incident surface located on a side of the light source, and a lens for collimating light emitted from the light source;
a first fly's eye lens upon which the light exited from the light guide or the lens is incident; and
a second fly's eye lens arranged in such a manner as to be paired with the first fly's eye lens, and integrating and guiding light to an object to be illuminated.

2. An illuminating device, comprising:
a light source provided with one or a plurality of solid light-emitting elements;
a first fly's eye lens arranged close to a light-emission side of each solid light-emitting element, and having two or more convex lens portions allotted to each solid light-emitting element; and
a second fly's eye lens arranged in such a manner as to be paired with the first fly's eye lens, and integrating and guiding light to an object to be illuminated.

3. An illuminating device according to claim 1, comprising a polarization conversion system having a plurality of polarizing beam splitters for redirecting to a common polarization direction, on a light-exit side of the second fly's eye lens.

4. An illuminating device according to claim 2, comprising a polarization conversion system having a plurality of polarizing beam splitters for redirecting to a common polarization direction, on a light-exit side of the second fly's eye lens.

5. An illuminating device, comprising:
a polarization conversion system having a plurality of polarizing beam splitters for redirecting to a common polarization direction;
one or a plurality of solid light-emitting elements arranged close to a light-incident side of the polarization conversion system; and
a light integrating means for integrating and guiding exited light from the polarization conversion system to an object to be illuminated.

6. An illuminating device according to claim 5, wherein the light integrating means is formed of a first fly's eye lens, and a second fly's eye lens arranged in such a manner as to be paired with the first fly's eye lens.

7. An illuminating device according to claim 5, wherein the light integrating means is a rod integrator in a tube or a pole shape.

8. An illuminating device, comprising:
a light source formed of a plurality of solid light-emitting elements; and
a means for rendering uniform a light-emitting amount or a light-emitting color of each solid light emitting element.

9. An illuminating device according to claim 8, wherein the light-emitting color and the light-emitting amount are controlled by controlling an electric current value supplied to the solid light-emitting elements.

10. An illuminating device according to claim 8, wherein the light-emitting amount is controlled by controlling a pulse width of the electric current supplied to the solid light-emitting elements.

11. An illuminating device according to claim 9, wherein the light-emitting amount is controlled by controlling a pulse width of the electric current supplied to the solid light-emitting elements.

12. An illuminating device according to claims 8, comprising an optical system in which light from the light source is guided to an object to be illuminated without applying a light integration to the light from the light source.

13. An illuminating device according to claim 8, wherein the light source is arranged close to the object to be illuminated, and the light from the light source is directly guided to the object to be illuminated.

14. An illuminating device according to claim 1, wherein an aspect ratio of each solid light-emitting element is rendered equal to or approximately equal to an aspect ratio of the object to be illuminated.

15. An illuminating device according to claim 2, wherein an aspect ratio of each solid light-emitting element is rendered equal to or approximately equal to an aspect ratio of the object to be illuminated.

16. An illuminating device according to claim 5, wherein an aspect ratio of each solid light-emitting element is rendered equal to or approximately equal to an aspect ratio of the object to be illuminated.

17. An illuminating device according to claim 8, wherein an aspect ratio of each solid light-emitting element is rendered equal to or approximately equal to an aspect ratio of the object to be illuminated.

18. An illuminating device according to claim 1, wherein the solid light-emitting elements are formed of light-emitting diodes having photonic crystals.

19. An illuminating device according to claim 2, wherein the solid light-emitting elements are formed of light-emitting diodes having photonic crystals.

20. An illuminating device according to claim 5, wherein the solid light-emitting elements are formed of light-emitting diodes having photonic crystals.

21. An illuminating device according to claim 8, wherein the solid light-emitting elements are formed of light-emitting diodes having photonic crystals.

22. An illuminating device according to claim 18, wherein the light-emitting diodes having the photonic crystals have a light-emission direction approximately vertical to a light-emitting surface.

23. An illuminating device according to claim 19, wherein the light-emitting diodes having the photonic crystals have a light-emission direction approximately vertical to a light-emitting surface.

24. An illuminating device according to claim 20, wherein the light-emitting diodes having the photonic crystals have a light-emission direction approximately vertical to a light-emitting surface.

25. An illuminating device according to claim 21, wherein the light-emitting diodes having the photonic crystals have a light-emission direction approximately vertical to a light-emitting surface.

26. A projection type video display for modulating light emitted from an illuminating device by a display device and projecting the modulated light, comprising the illuminating device according to any one of claims 1, 2, 5, or 8, wherein the display device is an object to be illuminated.

27. A projection type video display according to claim 26, wherein three pieces of the display devices are provided for respective colors, three the illuminating devices are provided for the respective colors, and light via the three pieces of display devices are composed and projected.

28. A projection type video display, comprising:
a self-light-emitting display device having a plurality of solid light-emitting elements as pixels; and
a projection optical element for projecting emitted image light from the self-light-emitting display device.

29. A projection type video display according to claim 28, wherein three pieces of the display devices are provided for respective colors, three the self-light-emitting display devices are provided for the respective colors, and emitted image light from the three pieces of self-light-emitting display devices are composed and projected.

30. A projection type video display according to claim 28, wherein the solid light-emitting elements in the display devices are formed of light-emitting diodes having photonic crystals.

31. A projection type video display according to claim 29, wherein the solid light-emitting elements in the display devices are formed of light-emitting diodes having photonic crystals.

32. An illuminating device according to claim 30 or 31, wherein the light-emitting diodes having the photonic crystals have a light-emission direction approximately vertical to a light-emitting surface.
